(19) United States
(12) Patent Application Publication
(10) Pub. No.: US 2012/0327667 A1
(43) Pub. Date: Dec. 27, 2012

(54) LED LIGHT SHADE FOR SECONDARY LIGHT EMISSION

(76) Inventor: Ken-sheng Chiang, Oceanside, CA (US)

(21) Appl. No.: 12/998,690

(22) PCT Filed: Jun. 24, 2010
(86) PCT No.: PCT/CN2010/074385

§ 371 Date: Aug. 31, 2012

(30) Foreign Application Priority Data
Jun. 10, 2010 (CN) 201010197222.9

(51) Int. Cl. F21V 9/16

(52) U.S. Cl. 362/351

(57) ABSTRACT

A LED light shade includes a shade body and a light enhancing layer integrated with a base material of the shade body. Alternatively, the light enhancing layer is coated on a surface of the shade body. When a LED light source is electrified, the LED light source generates LED light with a wavelength matching with the corresponding wavelength of light enhancing layer, such that the light enhancing layer is activated to enable a secondary light emission at the shade body so as to enhance the light intensity of the LED light. The light enhancing layer enables a secondary light emission that significantly increases the 30% brightness to produce the same lumens as a higher powered light. The LED light is evenly distributed through the shade body via the light enhancing layer. Therefore, the LED light shade is considered as an energy saving and environment friendly product.

### BACKGROUND OF THE PRESENT INVENTION

1. Field of Invention

The present invention relates to a LED apparatus, and more particular to a LED light shade which substantially enhance the light intensity from the LED light source to generate a secondary light emission when the LED light passes through the LED light shade.

2. Description of Related Arts

LED light apparatus is considered as an environmental light product to replace the conventional light bulb apparatus because LED light apparatus has a relatively long service life span, high light effect, no radiation emission, high shock resistance, and low energy consumption. Generally speaking, the conventional light apparatus, such as the LED lamp or LED light bulb, comprises a LED light source enclosed by a casing, wherein the casing is made of transparent material or composed of a light diffusion agent for diffusing the light from the LED light source. Accordingly, the casing with the light diffusion agent will reduce the light intensity from the LED light source because the casing will block or scatter a predetermined light from the LED light source so as to bounce back the light towards the LED light source. In addition, the interior structural design of the LED light apparatus cannot be seen through the casing with the light diffusion agent, such that the casing cannot keep the aesthetic appearance of the LED light apparatus.

### SUMMARY OF THE PRESENT INVENTION

The invention is advantageous in that it provides a LED light shade, which substantially enhances the light intensity from the LED light source and evenly distributes the LED light when the LED light passes through the LED light shade.

Additional advantages and features of the invention will become apparent from the description which follows, and may be realized by means of the instrumentalities and combinations particular point out in the appended claims.

According to the present invention, the foregoing and other objects and advantages are attained by a LED light shade for a LED light source, comprising a shade body arranged for LED light projecting thereto, and a light enhancing layer provided at the shade body, wherein the light enhancing layer comprises a mixture of fluorescent powder and pearlescent powder. The fluorescent powder can be in form of phosphor layer. Mixing the pearlescent with the fluorescent powder is to enhance the light efficiency of the secondary light emission when the LED light hits the light enhancing layer at the shade body. The light enhancing layer can be either integrated at an inner surface of the shade body or coated at an outer surface of the shade body.

Accordingly, the ratio of the mixture of fluorescent powder and pearlescent powder is that the 90 to 100 parts of fluorescent powder and 0-10 parts of pearlescent powder.

Preferably, the ratio of the mixture of fluorescent powder and pearlescent powder is that the 50 to 70 parts of fluorescent powder and 30-50 parts of pearlescent powder.

In accordance with the invention, the light enhancing layer can be integrally formed with the material of the shade body or can be coated on the surface of the shade body, wherein when the LED light source is electrified, the LED light source will generate LED light with a wavelength matching with the corresponding wavelength of light enhancing layer, such that the light enhancing layer is activated to enable a secondary light emission at the shade body so as to enhance the light intensity of the LED light. In other words, the wavelength of the fluorescent powder matches to the wavelength of the LED light from the LED light source to generate a secondary light emission. Therefore, the light enhancing layer enables the secondary light emission that significantly increases the brightness/produce more lumens to offer the possibility of further power savings to produce the same lumens as a higher powered light. Accordingly, the light intensity of the LED light can increase at least 30% through the light enhancing layer. According to the test result, the present invention increases more than 50% of the conventional LED light apparatus. In addition, the LED light will be evenly distributed through the surface of the shade body via the light enhancing layer. Therefore, the LED light shade can be considered as an energy saving and environment friendly product.

It is appreciated that different pigments of fluorescent powder and pearlescent powder can be mixed to form the light enhancing layer, such that the LED light shade is adapted to generate a light effect, such as different colors, when incorporating with the LED light source. In other words, the LED light shade can be incorporated to form any LED light apparatus, such as fluorescent tube, LED light bulb, or LED lamp, to generate different light effects so as to enhance the aesthetic appearance of the LED light apparatus.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a LED light shade according to a preferred embodiment of the present invention.

FIG. 2 illustrates an alternative mode of the LED light shade according to the above preferred embodiment of the present invention.

### DETAILED DESCRIPTION OF THE PREFERRED EMBODIMENT

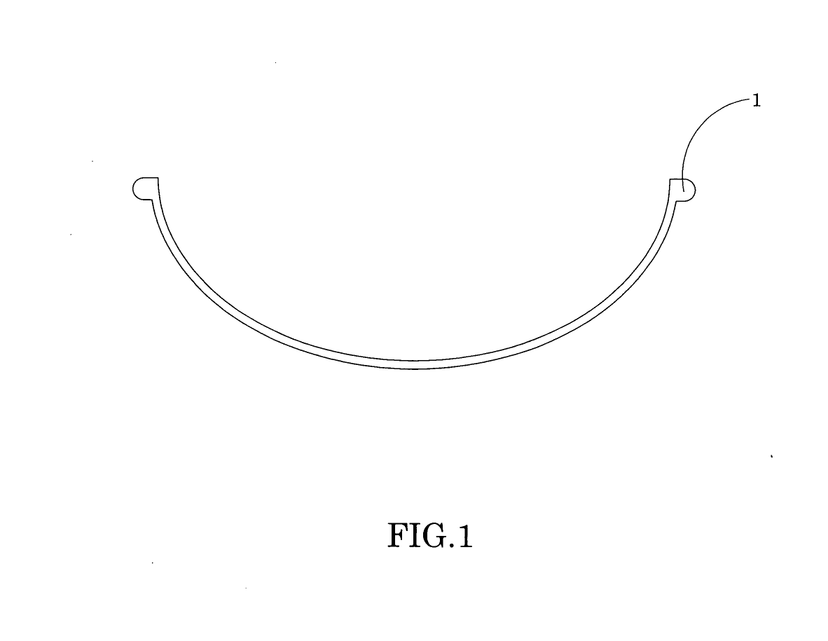

Referring to FIG. 1 of the drawings, a LED light shade according to a first preferred embodiment of the present invention is illustrated, wherein the LED light shade comprises a shade body 1 made of transparent material and arranged for LED light projecting thereto, and a light enhancing layer integrally provided at the shade body 1, wherein the light enhancing layer comprises a mixture of fluorescent powder and pearlescent powder. Accordingly, the light enhancing layer is integrally mixed with the base material of the shade body 1, wherein no reference number is assigned to the light enhancing layer.

Preferably, the ratio of the mixture of fluorescent powder and pearlescent powder is that the 90 parts of fluorescent powder and 10 parts of pearlescent powder.

Preferably, the ratio of the mixture of base material of the shade body 1 and the light enhancing layer is that the 50 parts of the base material of the shade body 1 and 50 parts of the light enhancing layer.

FIG. 1 also illustrates a second embodiment of the LED light shade, the base material of the shade body 1, fluorescent powder and pearlescent powder are well-mixed to form the shade body 1.

Preferably, the ratio of the mixture of fluorescent powder and pearlescent powder is that the 90 parts of fluorescent powder and 10 parts of pearlescent powder.

Alternatively, the ratio of the mixture of base material of the shade body 1 and the light enhancing layer is that the 70 parts of the base material of the shade body 1 and 30 parts of the light enhancing layer.

FIG. 1 also illustrates a third embodiment of the LED light shade, the base material of the shade body 1, fluorescent powder and pearlescent powder are well-mixed to form the shade body 1.

Preferably, the ratio of the mixture of fluorescent powder and pearlescent powder is that the 100 parts of fluorescent powder and 0 parts of pearlescent powder. In other words, the light enhancing layer only contains fluorescent powder.

Alternatively, the ratio of the mixture of base material of the shade body 1 and the light enhancing layer is that the 50 parts of the base material of the shade body 1 and 50 parts of the light enhancing layer.

FIG. 1 also illustrates a fourth embodiment of the LED light shade, the base material of the shade body 1, fluorescent powder and pearlescent powder are well-mixed to form the shade body 1.

Preferably, the ratio of the mixture of fluorescent powder and pearlescent powder is that the 100 parts of fluorescent powder and 0 parts of pearlescent powder. In other words, the light enhancing layer only contains fluorescent powder.

Alternatively, the ratio of the mixture of base material of the shade body 1 and the light enhancing layer is that the 70 parts of the base material of the shade body 1 and 30 parts of the light enhancing layer.

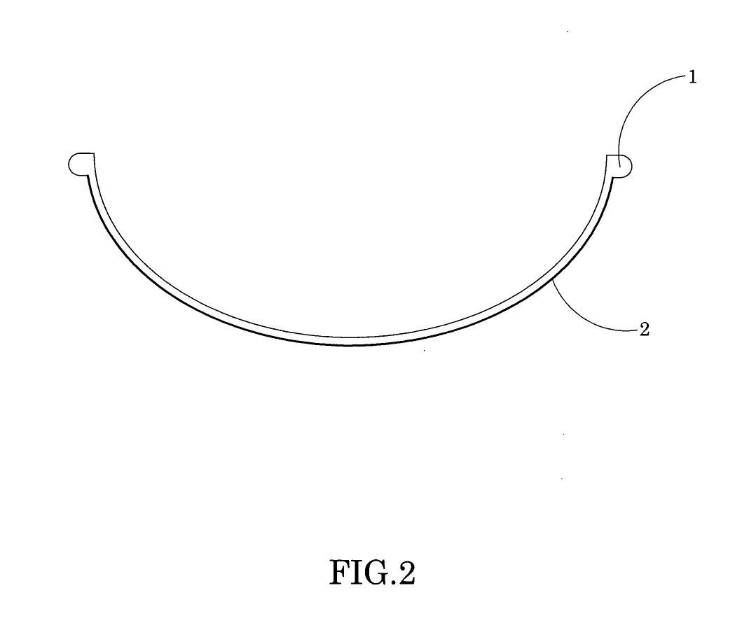

FIG. 2 illustrates a fifth embodiment of the LED light shade, wherein the light enhancing layer 2 is coated at a surface of the shade body 1. Preferably, the light enhancing layer 2 is coated at an outer surface of the shade body 1.

Accordingly, the ratio of the mixture of fluorescent powder and pearlescent powder is that the 90 parts of fluorescent powder and 10 parts of pearlescent powder.

FIG. 2 also illustrates a sixth embodiment of the LED light shade, wherein the light enhancing layer 2 is coated at a surface of the shade body 1. Preferably, the light enhancing layer 2 is coated at an outer surface of the shade body 1.

Accordingly, the ratio of the mixture of fluorescent powder and pearlescent powder is that the 90 parts of fluorescent powder and 10 parts of pearlescent powder. In other words, the light enhancing layer only contains fluorescent powder.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED light shade for a LED light source, comprising a shade body made of base material and arranged for LED light projecting thereto, and a light enhancing layer provided at the shade body, wherein said light enhancing layer comprises a mixture of fluorescent powder and pearlescent powder to generate a secondary light emission when LED light hits said light enhancing layer at said shade body, wherein said light enhancing layer is integrally mixed with said base material of said shade body.

2. A LED light shade for a LED light source, comprising a shade body arranged for LED light projecting thereto, and a light enhancing layer provided at the shade body, wherein said light enhancing layer comprises a mixture of fluorescent powder and pearlescent powder to generate a secondary light emission when LED light hits said light enhancing layer at said shade body, wherein said light enhancing layer is coated at a surface of said shade body.

3. The LED light shade, as recited in claim 1, wherein a ratio of said mixture of fluorescent powder and pearlescent powder is 90-100 parts of fluorescent powder and 0-10 parts of pearlescent powder.

4. The LED light shade, as in claim 1 or 3, wherein a ratio of the mixture of said base material and said light enhancing layer is 50-70 parts of fluorescent powder and 30-50 parts of light enhancing layer.

5. The LED light shade, as recited in claim 2, wherein a ratio of said mixture of fluorescent powder and pearlescent powder is 90-100 parts of fluorescent powder and 0-10 parts of pearlescent powder.
